(19) United States
(12) Patent Application Publication
(10) Pub. No.: US 2008/0243391 A1
(43) Pub. Date: Oct. 2, 2008

(54) Information Managing/Providing System and Method

(75) Inventors: Yoichi Ohshiro, Tokyo (JP); Kouji Ohmoto, Tokyo (JP); Takashi Ogawa, Tokyo (JP); Hikaru Yamada, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: The Tokyo Electric Power Company, Incorporated, Tokyo (JP)

(21) Appl. No.: 10/592,665

(22) PCT Filed: Jun. 22, 2006
(86) PCT No.: PCT/JP06/12544

§ 371 Date: Jan. 3, 2007

(30) Foreign Application Priority Data
Dec. 20, 2005 (JP) 2005-366610

(51) Int. Cl. G06F 19/00

(52) U.S. Cl. 702/2; 702/1

(57) ABSTRACT

There is provided n information managing/providing system including a plurality of clients (2) and server (3). Each of the clients (2) includes a plurality of sensor units (10) to detect environmental information on a residential house, receiver (11) to receive the housing-environmental information sent from the sensor unit (10) according to a predetermined radio communication standard, housing-environmental information storage unit (12) to store the housing-environmental information, and a transmitter (13) to send the housing-environmental information to the server (3). The server (3) extracts arbitrary information on the basis of the housing-environmental information supplied from the client (2) and provides the extracted information to a pre-registered user via a network. At occurrence of a disaster, information on the disaster to a residential house having the client (2) installed therein is generated based on the housing-environmental information stored in an information storage (61) and provided via the network.

### TECHNICAL FIELD

The present invention relates to an information managing/providing system and method in which housing-environmental information is detected by various sensors having a function of radio communication, the detected environmental information is collected from each of residential houses and environmental information or disaster (security) information on the residential house is provided.

This application claims the priority of the Japanese Patent Application No. 2005-366610 filed in the Japanese Patent Office on Dec. 20, 2005, the entirety of which is incorporated by reference herein.

### BACKGROUND ART

Heretofore, it has been proposed to monitor the present state of each of residential houses and alarm a fire, gas leak, emergency, crime or the like. Also, a system has been proposed in which each of the residential house owners (subscriber or contractant) makes a contract for protection under an online security system with a security company, information collected by monitoring is sent to the security company and the security company dispatches a security guard or guides to a subscriber's residential house in question for taking measures against a fire, break-in of an unwanted people or the like at that house (as in the Japanese Patent Laid Open No. 2004-80074).

However, implementation of such a conventional security system needs wiring work for installation of various sensors, complicated set-up work, etc. at each of the subscribers' residential houses, which will add to the initial costs for each of the subscribers' residential houses.

Also, there have been reported many earthquake-caused second disasters including fire cases. The typical ones of such fire cases are as follows. When the power transmission stopped once due to an earthquake was resumed after completion of the latter, an electric heater having been deenergized due to the power interruption was turned on again to inflame an inflammable material having fallen on the electric heater, thus resulting in a fire. Also, when the power transmission stopped once due to an earthquake as above was resumed after the earthquake was over, a heater used in a tropical fish water bath fallen on the floor due to the earth quake, having been deenergized due to the power interruption, was turned on again with the water being spilled from the bath on the floor and became abnormally hot to inflame an inflammable material near the heater, thus resulting in a fine. To prevent such second disasters, those engaged in the power transmission visit each of the residential houses for safety confirmation before resuming the power transmission after the earthquake is over. However, the safety confirmation takes many workers and much time and thus the power transmission cannot be resumed rapidly after occurrence of a disaster.

### DISCLOSURE OF THE INVENTION

It is therefore desirable to overcome the above-mentioned drawbacks of the conventional art by providing an information managing/providing system and method, capable of accurately and rapidly collecting housing-environmental information and disaster information and providing the information.

It is also desirable to provide an information managing/providing system installable inexpensively and easily in an existent residential house as well and an information managing/providing method used in the system.

According an embodiment of the present invention, there is provided an information managing/providing system in which a plurality of client-side devices is connected to an external server that manages and provides information sent from each client-side device.

In the above system, a client-side device of the information managing/providing system includes a plurality of sensor units to detect housing-environmental information and send the detected housing-environmental information according to a predetermined radio communication standard, a housing-environmental information storage unit to receive the housing-environmental information sent from one or more of the sensor units installed in an arbitrary place in a residential house according to the predetermined radio communication standard and store the received housing-environmental information, and a transmitter to send the housing-environmental information stored in the housing-environmental information storage unit to a server via a network.

One of the sensor units includes at least an acceleration sensor that detects a vibration in a place where it is provided, as one of the housing-environmental information.

Also, the server includes an information storage unit to receive housing-environmental information supplied from the transmitter included in each of client-side devices and store the received housing-environmental information, a housing-environmental information providing unit to extract arbitrary information on the basis of the housing-environmental information stored in the information storage unit and provide the extracted information to a pre-registered user via a network, and a disaster information providing unit, put into operation at occurrence of a disaster, to generate information on the disaster to a residential house having a client installed therein on the basis of the housing-environmental information stored in the information storage.

Also, according to another embodiment of the present invention, there is provided an information managing/providing method used in the information managing/providing system.

According to the present invention, it is possible to provide various kinds of environmental information on a user's own residential house or arbitrary house from a remote site (it should be noted here that the user is a client having made a contract with a service provider (security company or the like) by following a due procedure) and disaster information on each of the user's own residential houses in a district affected by a disaster having occurred.

### BRIEF DESCRIPTION OF THE DRAWINGS

FIG. 1 is a block diagram of the information managing/providing system as an embodiment of the present invention.

FIG. 2 is also a block diagram of a client-side device in the information managing/providing system shown in FIG. 1.

FIG. 3 is a block diagram of a sensor unit in the client-side device in FIG. 2.

FIG. 4 is a block diagram of a connector in the client-side device in FIG. 2.

FIG. 5 illustrates a first security content generated by the client.

FIG. 6 illustrates a second security content generated by the client.

FIG. 7 illustrates a first electric-appliance monitoring content generated by the client.

FIG. 8 illustrates a second electric-appliance monitoring content generated by the client.

FIG. 9 illustrates a third electric-appliance monitoring content generated by the client.

FIG. 10 illustrates a first disaster-prevention content generated by the client.

FIG. 11 illustrates a second disaster-prevention content generated by the client.

FIG. 12 shows an example layout in a residential house of the components included in the client-side device in the information managing/providing system in FIG. 2.

FIG. 13 shows a flow of operations made in the client-side device in FIG. 2.

FIG. 14 is a block diagram of a server-side portion of the information managing/providing system as the embodiment of the present invention.

### BEST MODE FOR CARRYING OUT THE INVENTION

The present invention uses a wireless sensor network (WSN) complying with a predetermined wireless sensor standard (e.g., ZigBee (registered trademark)) and featured by a small size, reduced weight, inexpensiveness and power-saving, automatic build-up of a network, etc.

<Overall Configuration>

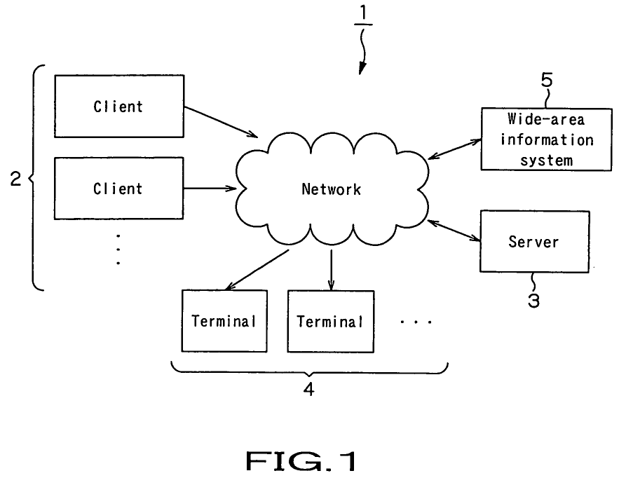

As shown in FIG. 1, the information managing/providing system as an embodiment of the present invention, generally indicated with a reference numeral 1, includes a plurality of client-side devices (will also be referred to simply as “client” hereunder wherever appropriate) 2, a server 3, a plurality of terminals 4 and a wide-area information system 5.

Each of the client-side devices 2 includes a sensor unit incorporating various sensors complying with the predetermined radio communication standard. The client-side device 2 is installed in each user's residential house to detect housing-environmental information by the sensor unit and sends the detected housing-environmental information to the server 3.

Note that the sensor unit forms a so-called ad-hoc network that can readily communicate with peripheral terminals without being wired and set.

The server 3 provides environmental information on a residential house having the client-side device 2 installed therein to each of the terminals 4 normally or at occurrence of a disaster and provides disaster information on a residential house having the client-side device 2 installed therein to each terminal 4 at occurrence of a disaster.

The server 3 provides the wide-area information system 5 with the stored housing-environmental information at occurrence of a disaster. The wide-area information system 5 extracts wide-area information on the basis of the provided housing-environmental information and provides the extracted wide-area information to, for example, a local government office in that district where the disaster has occurred and disaster risk management center administrated by the local government. The local government and disaster risk management center will prepare disaster information from the provided wide-area information and provides the prepared disaster information to the terminals 4 and terminals 4 in other many clients' residential houses and community facilities various cable or radio networks.

The terminal 4 is, for example, a PC (personal computer), mobile telephone or the like. Main users of the terminals 4 are a couple as a client wanting to monitor the conditions of their parents living in a remote place, care manager engaged in monitoring the conditions of people as clients having made a care management contract with the care manager, security company to monitor the home situation of people as clients having made a security service contract with the company, etc.

Each of the components included in the information managing/providing system 1 will be explained in detail below with reference to the accompanying drawings.

<Configuration of the Client-Side Device>

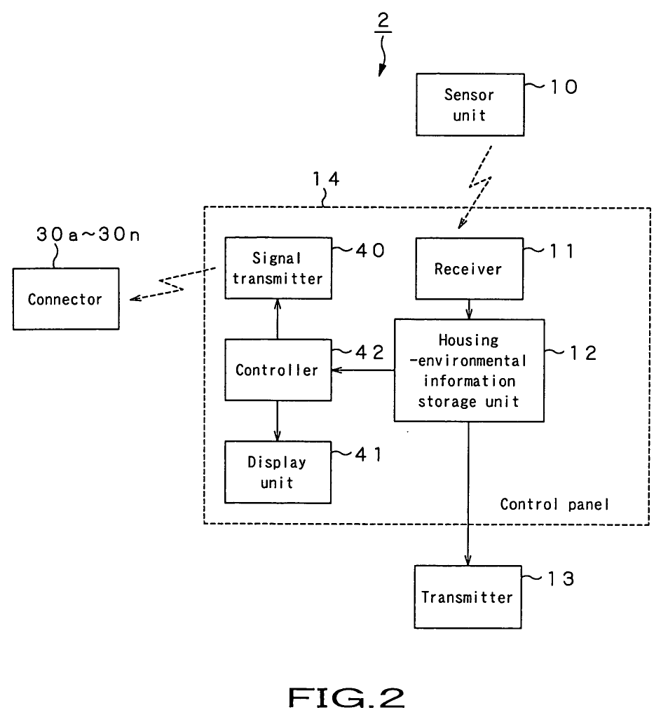

As shown in FIG. 2, the client-side device 2 included in the information managing/providing system 1 as the embodiment of the present invention includes a sensor unit 10 to detect housing-environmental information and send the detected housing-environmental information according to the predetermined radio communication standard (e.g., IEEE 802.15.4 (ZigBee)(registered trademark)), a receiver 11 to receive the housing-environmental information sent from one or more of the sensor units 10 installed in an arbitrary place in a residential house according to the predetermined radio communication standard, a housing-environmental information storage unit 12 to store the received housing-environmental information, and a transmitter 13 to send the housing-environmental information stored in the housing-environmental information storage unit 12 to the server 3 via a network.

Note that in the following description, it is assumed that the receiver 11, housing-environmental information storage unit 12 and transmitter 13 are provided together in a control panel (CP) 14.

The sensor unit 10 is configured as will be described below.

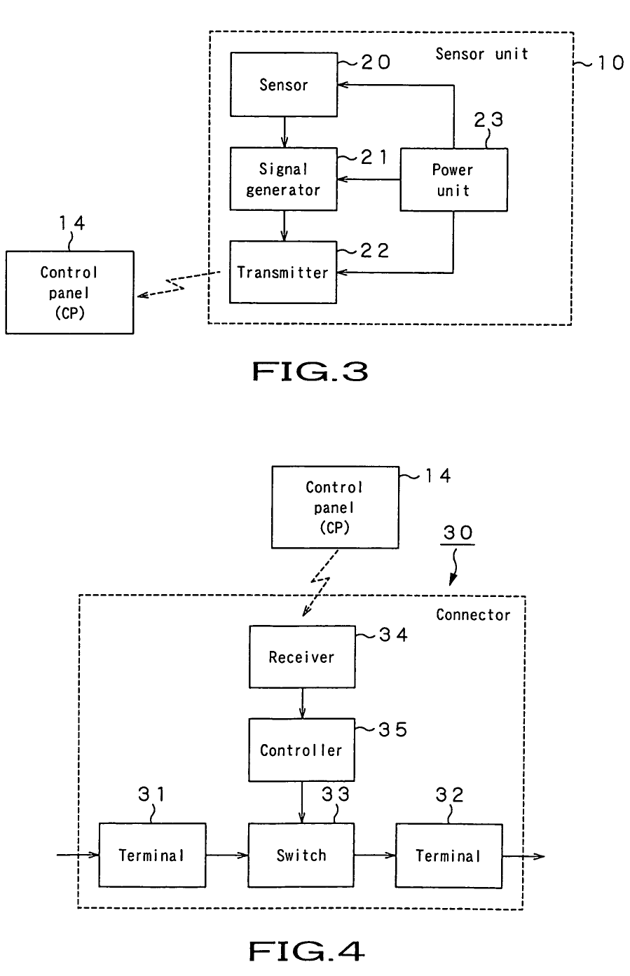

As shown in FIG. 3, the sensor unit 10 includes a sensor 20 to detect environmental information, signal generator 21 to generate a predetermined signal S1 on the basis of a value detected by the sensor 20, transmitter 22 to send the generated signal S1 to CP 14, and a power unit 23 to supply a power to each of the components.

Of the client 2 included in the present invention, a plurality of sensor units 10 is installed in arbitrary places in the client's residential house. At least one of the sensor units 10 is used to detect vibration in a place where it is installed. The sensor 20 is an acceleration sensor to detect a swing caused by an earthquake. The acceleration sensor uses, for example, a gyroscope to detect such a swing.

The sensor unit 10 including the acceleration sensor as the sensor 20 is installed at a fixed portion, for example, on the wall surface of a residential house.

Also, the sensor unit 10 may be provided with a setting unit to set a swing intensity (seismic intensity) the sensor 20 (acceleration sensor) will respond to. With the setting unit, it is possible to set a swing intensity at which a switch 33 is to be turned off, for example. That is, the setting unit can be used to set a swing intensity at which the sensor unit 10 will not detect a slight earthquake, vibration caused in daily life or the like.

In the sensor unit 10, the sensor 20 may also be a sensor to monitor a change inside the residential house. For example, the sensor 20 may be formed from a smoke/fire sensor to detect smoke or fire. Also, the sensor 20 may be a door/window open/closed state sensor to detect whether a door and window is open or closed, image sensor to detect a movement of a person or a thermosensor to measure the room temperature. Further, the sensor 20 may be a water leak sensor to detect a leak from a water pipe or the like. Also, the sensor 20 may be an electric leak sensor to detect an electric leak or a gas leak sensor to detect a gas leak.

Note that the fire/smoke sensor is to detect a temperature and smoke by infrared detection and gas detection. Also, the door/window open/closed state sensor is to measure a difference in electrical resistance between when the door or window is “open” and when it is “closed”, for example, to detect whether the door or window is open or closed. The image sensor is to detect a movement of a person with the use of infrared rays, for example. The temperature sensor or thermosensor is to measure a temperature depending upon the amount of infrared rays, for example. The water leak sensor detects a water leak depending upon whether its electrodes are shorted between them due to the water leak, for example. The gas leak sensor is to detect a gas leak depending upon whether the gas concentration exceeds a predetermined value. Further, the sensor 20 to detect a person's movement may be combined with a camera that images the person in response to the detection of the person's movement by the sensor 20, which is one of the possible applications of the sensor unit 10.

Also, the electric leak sensor is to monitor an electric leak always or at constant intervals (15 min, 30 min or the like) by a leakage current measuring instrument using a zero-phase-sequence current transformer (ZCT) installed on each of an in-house main line of a power line, distribution board, power meter or the like. When an electric leak exceeding a set value is detected, the sensor unit 10 using the electric leak sensor generates a signal S1 and sends the generated signal S1 from the transmitter 22 to the receiver 11 of CP 14. Thus, the information managing/providing system 1 as the embodiment of the present invention can make checking of the insulated state (electric leak) which has been done by the power company and thus save the labor. Further, the electric leak sensor can always monitor the insulation resistance and leakage current, which always vary, whereby it is possible to further improve the electrical safety.

Also, a combination of the sensors in the sensor unit 10 is appropriately determined depending upon the intended use of the information managing/providing system 1 as the embodiment of the present invention. For example, in case the system 1 is to be used for crime prevention, the sensor 20 is formed from a door/window open/closed state sensor, image sensor and a sensor camera in combination.

Also, for use of the system 1 to control electric appliances, the sensor 20 is formed from a combination of a sensor to detect whether a connector 30 which will be described in detail later is on or off, sensor to detect whether an illumination light switch is on or off and a thermosensor to detect the room temperature.

Also, for utilization of the system 1 to monitor the power consumption and the like in a residential house, the sensor 20 is formed from a combination of a power consumption sensor to detect a power consumption at every arbitrary time, gas consumption sensor to detect a gas consumption at every arbitrary time and a tap water consumed-amount sensor to detect a consumed amount of tap water.

Also, for use of the system 1 to provide information at occurrence of a disaster, the sensor 20 is formed from a sensor unit including various leak sensors, a sensor including an acceleration sensor to detect a vibration and a sensor unit including a smoke/fine sensor in combination.

The sensor unit 10 is of a power-saving type and it uses the power unit 23 which is a small battery capable of working for more than a year so long as it is used with a normal operation frequency. The sensor unit 10 has not to be connected to any AC power source and thus independent of the system power line of the power company. Therefore, the sensor unit 10 can continuously operate even when no power is supplied to the system power line due to a power interruption.

Also, the client (client-side device) 2 has connectors 30a to 30n connected at one end thereof to a system power line A and at the other end to electric appliances 100a to 100n and each of which connects or disconnects the power supplied from the system power line A to the electric appliances 100a to 100n on the basis of a predetermined signal sent from CP 14.

Note that each of the electric appliances 100a to 100n is, for example, an electric heater, bath heater which heats water in a water bath or the like. It has a function to convert electricity into heat or a similar function.

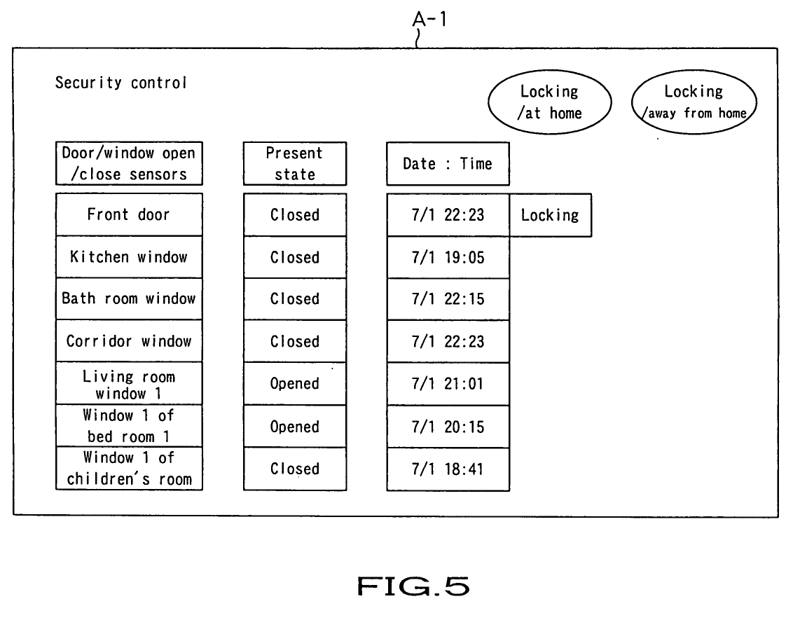

Each of the connectors 30a to 30n is constructed and operates as will be described below. As shown in FIG. 4, each connector 30 includes, for example, a plug-shaped terminal 32 to be plugged into a receptacle type outlet provided on a wall of a residential house and electrically connected, to the outlet, receptacle-type terminal 32 to supply a power to the electric appliance 100, switch 33 to make electrical connection or disconnection between the terminals 31 and 32, receiver 34 to receive a signal S2 supplied from CP 14, and a controller 35 to turn off the switch 33 on the basis of the signal S2 received by the receiver 34.

Note that the switch 33 is kept turned on normally (while no signal S2 is supplied from CP 14). Therefore, being supplied with a power from the system power line A, the electric appliance 100 is ready for operation.

CP 14 is a so-called sensor server. As shown in FIG. 2, it includes a receiver 11 to receiver housing-environmental information sent from each sensor unit 10, housing-environmental information storage unit 12 to store the received housing-environmental information, transmitter 13 to send the stored housing-environmental information to the server 3, signal transmitter 40 to send a predetermined signal conforming to the predetermined radio communication standard to the components such as the connectors 30a to 30n, display unit 41 to indicate the housing-environmental information stored in the housing-environmental information storage unit 12, and a controller 42 to control the entire CP 14.

The housing-environmental information storage unit 12 is formed from a memory element such as a hard disk, semiconductor memory or the like. Constantly, periodically or when a result of a detection made by the sensor 20 exceeds a predetermined value, it stores the result of detection, sent from the transmitter 22 of the sensor unit 10, as housing-environmental information for a predetermined period (several hours, several days or several weeks or the like). Constantly or at predetermined intervals, the transmitter 13 sends, to the server 3, the housing-environmental information stored in the housing-environmental information storage unit 12.

Note that the housing-environmental information may be sent to the server 3 either constantly or at predetermined intervals at occurrence of no disaster but at predetermined intervals (15 min, 30 min or the like) when a disaster has occurred. The latter case is intended for preventing a communication error from taking place and the communications from being made impossible when the power and communication lines are disconnected at recovery of the power supply. The server 3 receiving housing-environmental information at the predetermined intervals at occurrence of a disaster will be able to get housing-environmental information which used to be when at least the power and communication lines have been disconnected several tens of minutes.

Also, since the client 2 adopts the ZigBee (registered trademark) for signal sending and reception, a signal can be sent and received even if there exists a shield such as a wall, partition or the like between the components, for example, between one of the sensor units 10 and CP 14.

Note that the client 2 is described in further detail in the Japanese Patent Application No. TE-02-PCT filed on the same day as the application date of the present invention and this application is also incorporated as a reference in the present invention.

<Operation of the Client 2>

CP 14 operates as will be explained below.

The controller 42 analyzes the housing-environmental information stored in the housing-environmental information storage unit 12, generates a security control content A-1 as shown in FIG. 5 from the result of detection from the door/window open/closed state sensors (for example, information that the door or window is open or closed, information on the latest opening or closing of the door or window, information on locking of the door or window or the like) from the door/window open/closed state sensors and indicates the generated content A-1 on the display unit 41. The security control content A-1 indicated on the display unit 41 indicates whether the door and window of the residential house in consideration is open or closed, a time of the latest opening or closing of the door and window, and whether the door and window are locked. Watching the security control content A-1, the user can know whether the door and window of his or her own residential house are open or closed.

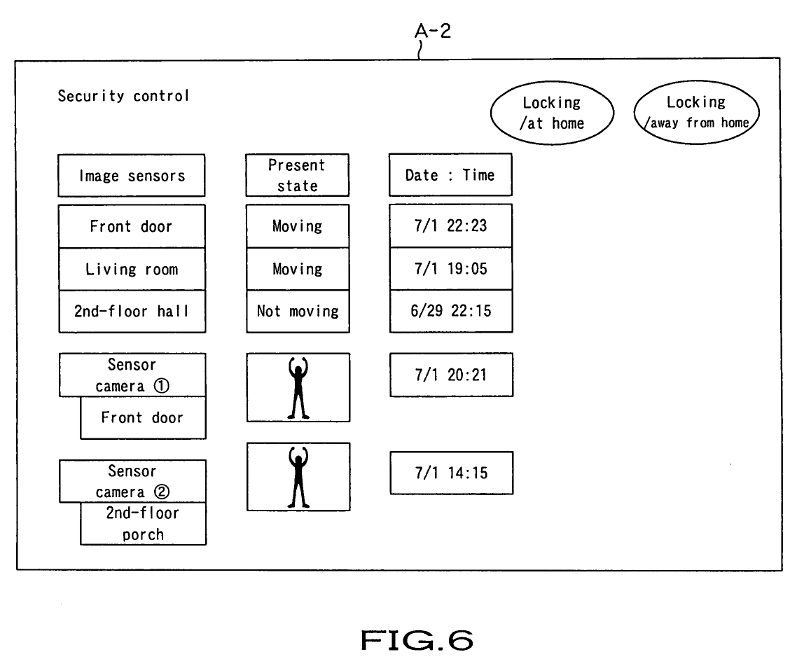

Also, the controller 42 analyzes the housing-environmental information stored in the housing-environmental information storage unit 12, generates a security control content A-2 as shown in FIG. 6 from the result of detection from the image sensors and sensor cameras (for example, information on whether the image sensors are on, image captured by the sensor camera, information on a time when the image sensor or sensor camera has been put into action, etc.) and indicates the generated content A-2 on the display unit 41. The security control content A-2 indicated on the display unit 41 indicates whether the image sensor in the residential house in consideration is put in operation, a time when the image sensor has been put into action, image captured by the sensor camera, time of the imaging, etc. Watching the security control content A-2, the user can know how his house is (for example, whether any one has broken into the user's house).

Therefore, the information managing/providing system 1 permits the user to know the current condition in and around his house by watching the security control contents A-1 and A-2 indicated on the display unit 41, and thus the user can take quick and appropriate actions against any abnormality of his house.

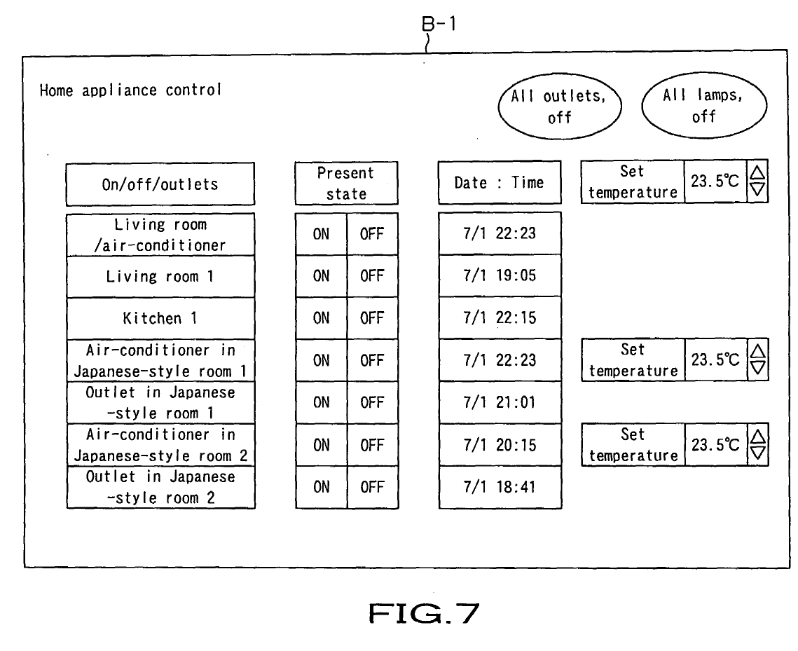

Also, the controller 42 analyzes the housing-environmental information stored in the housing-environmental information storage unit 12, generates a home appliance monitoring content B-1 as shown in FIG. 7 from the result of detection from the sensor that detects whether the connector 30 is on or off (for example, information on whether the connector 30 is on or off, time when the connector 30 has been turned on or off, etc.) and indicates the generated content B-1 on the display unit 41. The home appliance monitoring content B-1 indicated on the display unit 41 indicates whether the connector 30 laid between the outlet and electric appliance in the house in consideration is on or off and a time when the connector 30 has been turned on or off. The display unit 41 can also be used to control the system. By touching the “All outlets, off” button, for example, the user can forcibly turn off all the connectors 30. Further, the display unit 41 may be designed to control the home appliances themselves. In this case, the temperature setting of an air-conditioner can appropriately be changed, for example.

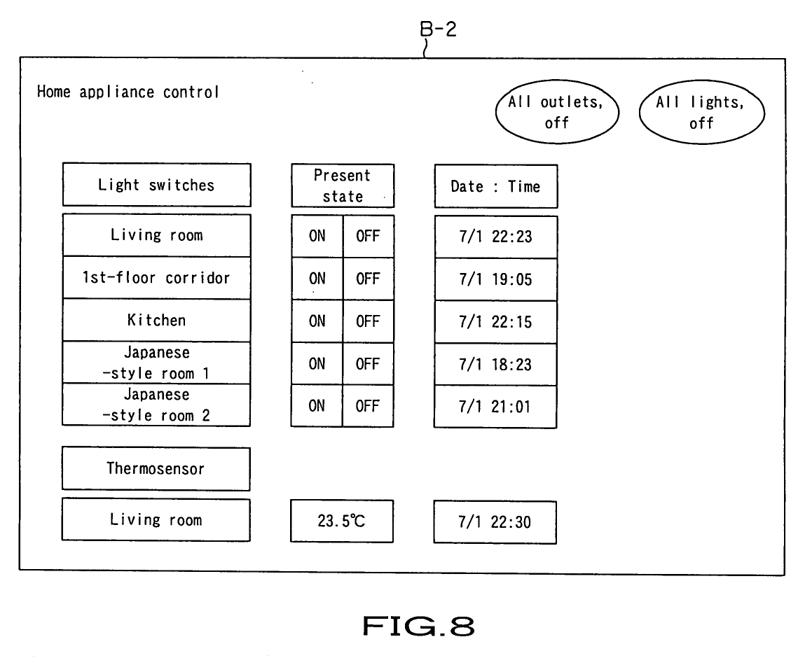

Also, the controller 42 analyzes the housing-environmental information stored in the housing-environmental information storage unit 12, generates a home appliance monitoring content B-2 as shown in FIG. 8 from the results of detection from the sensor that detects whether the illumination switch is on or off and the thermosensor (for example, information on whether the illumination switch is on or off, time when the illumination switch has been turned on or off, temperature detected by the thermosensor, etc.) and indicates the generated content B-2 on the display unit 41. The home appliance monitoring content B-2 indicated on the display unit 41 indicates whether the illumination switch in the house in consideration is on or off, time when the illumination switch has been turned on or off and information on a temperature in a place where the thermosensor is installed. The display unit 41 can also be used to control the illumination switch. By touching the “All outlets, off” button, for example, the user can forcibly turn off all the connectors 30.

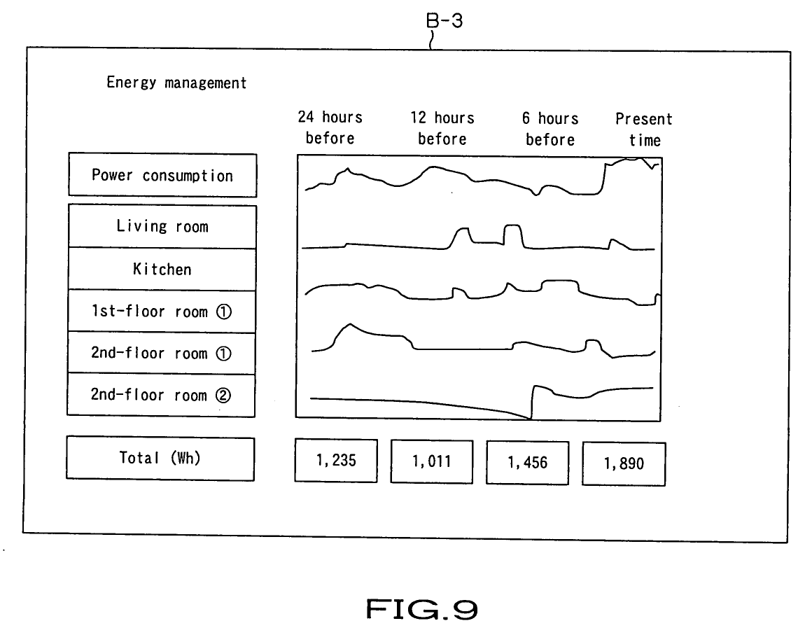

Also, the controller 42 analyzes the housing-environmental information stored in the housing-environmental information storage unit 12, generates a home appliance monitoring content B-3 as shown in FIG. 9 from the result of detection from the power consumption sensor (for example, time-varying information on power consumption) and indicates the generated content on the display unit 41. The home appliance monitoring content B-3 indicated on the display unit 41 indicates a time-varying power consumption in a residential house.

Note that the power consumption may be indicated in units of hours or days.

Therefore, the information managing/providing system 1 permits the user to know the current state of his residential house because it can provide the above-mentioned home appliance monitoring contents B-1, B-2 and B-3 to the user.

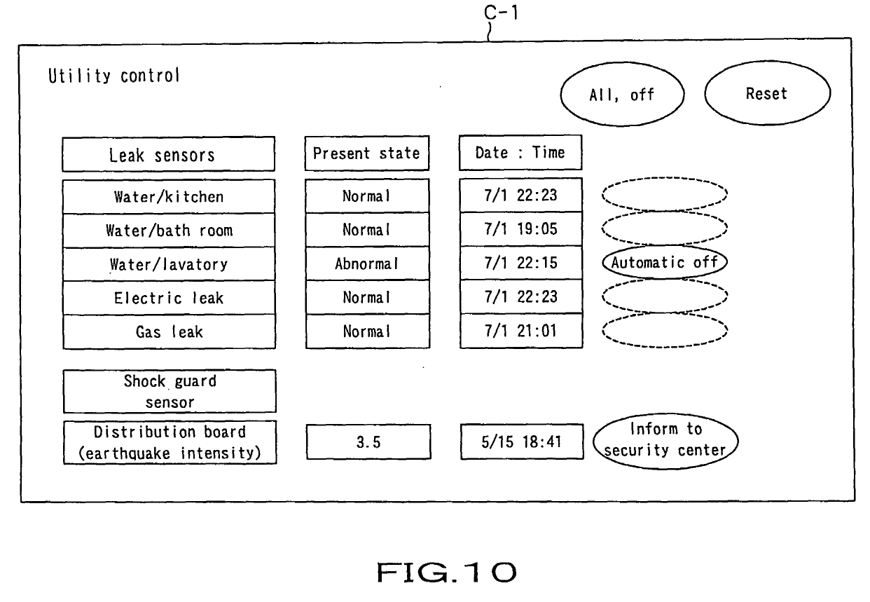

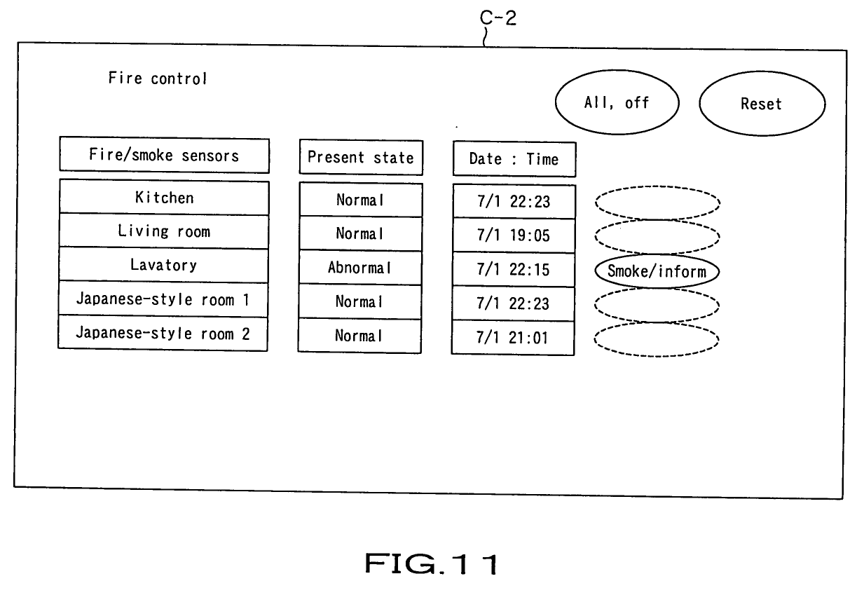

Also, the controller 42 analyzes the housing-environmental information stored in the housing-environmental information storage unit 12, generates a utility control content C-1 as in FIG. 10 and fire control content C-2 as in FIG. 11 from the results of detection from various wetting sensors, acceleration sensor and smoke/fine sensor (for example, information on water leak, electric leak and gas leak in the kitchen or the like, seismic intensity information, information on a smoke or fire in the kitchen or the like) and indicates the generated contents on the display unit 41. The utility control contents C-1 indicated on the display unit 41 indicate information on whether there is water leak in the kitchen, bath room and lavatory, information on electric leak, information on gas leak, earthquake information and in formation on times when these pieces of information have been detected.

Note that a remote-controllable valve is provided in the water pipe to close the latter at occurrence of an earthquake, a remote-controllable circuit breaker is provided near the distribution board to shut off the electric power supply at occurrence of an earthquake and a remote-controllable valve is provided in a gas pipe to shut off gas supply at occurrence of an earthquake.

The display unit 41 also functions to control the system components. For example, by touching the “all outlets, off” button, the user can forcibly close the valve in the water pipe and shut off the power supply and gas supply. Also, by touching the “Reset” button, the user can open the water pipe, resume the power supply and open the gas pipe.

The fire prevention content C-2 indicated on the display unit 41 indicates information on any abnormality in the kitchen, living room, lavatory, Japanese-style room 1 or 2 (“Abnormal” when the smoke/fire sensor is activated) and information on a time when the information has been detected.

Therefore, the information managing/providing system 1 can permit the user to known the current state of the user's residential house by providing the utility control content C-1 and fire control content C-2 to the user. Thus, the user can quickly take appropriate measures against such an abnormality.

<Operation of Client 2 at Occurrence of a Disaster>

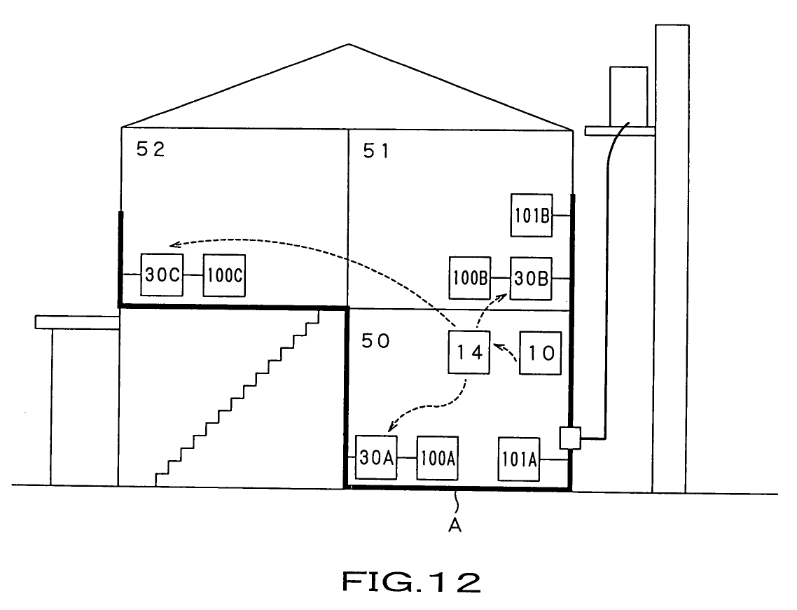

The client 2 operates at occurrence of a disaster as will be described below. FIG. 12 is a schematic sectional view of a residential house (including rooms 50 to 52). As shown in FIG. 12, a power is led from outside the residential house into the latter via the system power line A and supplied to each of the rooms 50 to 52 via the system power line A. Also, in the room 50, an electric appliance 100A is provided being connected to the system power line A via a connector 30A, an electric appliance 101A is provided being connected directly to the system power line A, and there are also disposed the sensor unit 10 including an acceleration sensor as the sensor 20, and CP 14. Also, in the room 51, an electric appliance 100B is connected to the system power line A via the connector 30B and an electric appliance 101B is connected directly to the system power line A. Also, in the room 52, an electric appliance 100C is connected to the system power line A via the connector 30C.

Note that the electric appliances 101A and 101B connected directly to the system power line A are a telephone set or the like. Different from the electric appliance 100, they are, for example, a device which has not the function to make electricity-heat conversion and will not thus cause any fire or the like even if it falls down at occurrence of a disaster. Also, electric appliances connected to the connectors 30A, 30B and 30C are, for example, an electric heater and bath heater to warm water in a water bath, having the function of electricity-heat conversion.

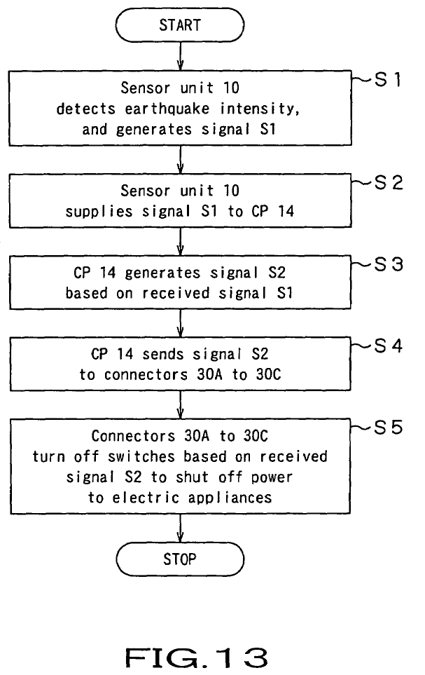

The client 2 operates at occurrence of an earthquake in a district where the residential house is located as will be described below with reference to the flow diagram in FIG. 13.

At occurrence of an earthquake, the sensor unit 10 detects the intensity of the earthquake, and generates a signal S1 (in step S1). Then, the sensor unit 10 sends the generated signal S1 to CP 14 (in step S2).

CP 14 generates a signal S2 on the basis of the received signal S1 (in step S3) and sends and sends the signal S2 to the connectors 30A, 30B and 30C (in step S4).

CP 14 operates as will be described below. The receiver 11 receives the signal S1 sent from the sensor unit 10. Next, the controller 42 generates a signal S2 on the basis of the received signal S1, and controls the signal transmitter 40. The signal transmitter 40 is controlled by the controller 42 to generate a signal S2 and send it to each of the connectors.

The connector 30A turns off the switch on the basis of the received signal S2 to break the electrical connection, the connector 30B turns off the switch on the basis of the received signal S2 to break the electrical connection, and the connector 30C turns off the switch on the basis of the received signal S2 to break the electrical connection (in step S5).

Therefore, the electric appliances 100A, 100B and 100C, having no heat source, will not be supplied with the power. Namely, they will not be put into operation even when the power transmission is recovered thereafter and thus a second disaster such as a fire will be prevented from taking place.

On the other hand, the electric appliances 101A and 101B are connected directly to the system power line A. So, when the power transmission is recovered, they will be supplied with the power again. That is, the electric appliances 101A and 101B are not controlled by the respective connectors 30. When the power supply from the system power line A is resumed after the disaster, the power is supplied to these electric appliances which will thus be put into operation again. Therefore, the communication or the like by the telephone can be resumed.

Also, the connectors 30A, 30B and 30C, whose switches are turned off, may be designed to be turned on together by the user or individually with a manual operation by the user.

As above, the client 2 in the information managing/providing system 1 includes the connectors 30a to 30n connected at one end thereof to the system power line A and at the other end to the electric appliances 100, respectively, to connect or disconnect the power supplied from the system power line A to the electric appliances 100, sensor unit 10 to detect environmental information (such as information on the swing due to an earthquake, information on temperature and smoke due to a fire), and CP 14 to generate a predetermined signal on the basis of the environmental information detected by the sensor unit 10 and send the generated predetermined signal to the connectors 30a to 30n. With the connectors 30a to 30n being disposed between the electric plugs of the arbitrary (a plurality of) electric appliances 100 and outlets supplied with a power from the system power line A, the power supply to the arbitrary electric appliances 100 can forcibly be shut off at occurrence of an earthquake, the power transmission can be interrupted, and the power supply to the arbitrary electric appliances 100 can be kept interrupted even after the power transmission is resumed thereafter. Thus, any second disaster can be prevented from taking place.

<Configuration of the Server>

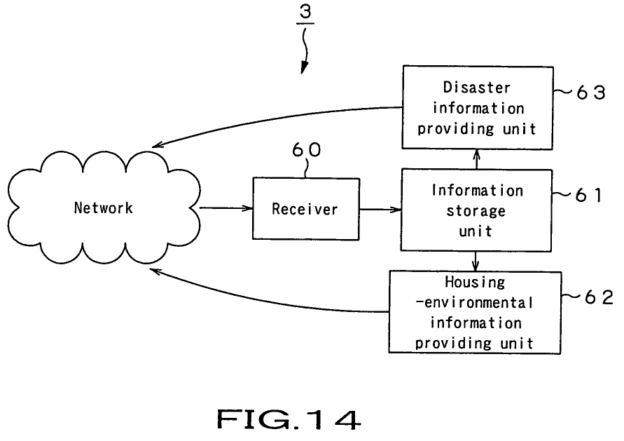

The server 3 in the information managing/providing system 1 as the embodiment of the present invention is configured as will be described below. As shown in FIG. 14, the server 3 includes a receiver 60 to housing-environmental information supplied from CP 14 in each client 2, information storage unit 61 to store the received housing-environmental information, housing-environmental information providing unit 62 to extract arbitrary information on the basis of the housing-environmental information stored in the information storage unit 61 and provide the extracted information to the pre-registered user via the network, and a disaster information providing unit 63 that is put into operation at occurrence of a disaster to generate disaster information on a residential housing having the client 2 installed therein on the basis of the housing-environmental information stored in the information storage unit 61 and provide the disaster information to the user via the network.

The receiver 60 receives the housing-environmental information supplied from CP 14 in each client 2 via the transmitter 13 normally, always or at predetermined intervals and stores the received housing-environmental information into the information storage unit 61 formed from a large-capacity hard disk or the like. Also, at occurrence of a disaster, the receiver 60 sends a request to send to CP 14 in each client 2 at predetermined intervals (15 min, 30 min or the like) for acquisition of housing-environmental information from CP 14. The acquisition of housing-environmental information at occurrence of a disaster is intended to prevent the communications from being made impossible when the power supply and communications have been shut off at occurrence of the disaster. The receiver 60 receives housing-environmental information at the predetermined intervals and stores the information into the information storage unit 61, to thereby permitting to acquire housing-environmental information which has been at least several tens minutes before the power supply and communications are shut off by the disaster.

The housing-environmental information providing unit 62 analyzes the housing-environmental information sent from a plurality of clients 2 to generate a content for display on the terminal in each residential house having the client 2 installed therein. The content is housing-environmental information equivalent to the aforementioned security control contents A-1 and A-2, home appliance contents B-1, B-2 and B-3 and the utility control content C-1 and fire control content C-2.

Also, the user having already made a predetermined registration can view, on his terminal 4, the contents sent from the housing-environmental information providing unit 62.

Therefore, the user of the information managing/providing system 1 as the embodiment of the present invention can know various pieces of environmental information on his house in a remote place, for example, by watching, on the terminal 4, the contents generated by the housing managing/providing unit 62. Thus, the user can take quick and appropriate measures against an abnormality of his house.

Also, the user of the information managing/providing system 1 as the embodiment of the present invention can know various pieces of environmental information on a house of his parents in a remote place, for example, by watching, on the terminal 4, the contents generated by the housing managing/providing unit 62. Thus, the user can know the safety of his parents from the results of detection from the sensor unit 10 (in which the sensor 20 is an acceleration sensor) disposed inside the door of a refrigerator, for example.

Also, at occurrence of a disaster, the disaster information providing unit 63 can provide, based on the housing-environmental information stored in the information storage unit 61, information to permit the user to know as follows.

The user can guess, from the result of detection from the door/window open/closed state sensor, that the door and window of the residential house have possibly been broken; from the result of detection from the image sensor, that any one has possibly been left in the house; from the result of detection from the thermosensor, that the house is possibly burning; from the result of detection from the leak sensor, that the house has possibly been flooded; from the result of detection from the electric leak sensor, that a fire has possibly taken place due to an electric leak; from the result of detection from the gas leak sensor, that a fire or explosion has possibly taken place due to a gas leak; and, from the result of detection from the acceleration sensor, a seismic intensity or that the house has possibly been collapsed; from the result of detection from the smoke/fire sensor, whether a fire has possibly occurred. Further, the disaster information providing unit 63 can generate information on the life line from the consumption of the electric power, gas and city water.

The disaster information providing unit 63 operates as will be described in detail below. At occurrence of a disaster, the disaster information providing unit 63 generates disaster information on the basis of the environmental information on each house, stored in the information storage unit 61. The disaster information includes, for example, information on the collapse of a house, predictive information on a survivor left in the house, etc.

Note that the disaster information providing unit 63 predicts the collapse of the residential house on the basis of the result of detection supplied from the sensor unit 10 in which the sensor is a distortion sensor and stored in the information storage unit 61, and a survivor left in the house on the basis of the result of detection supplied from the sensor unit 10 in which the sensor 20 is the image sensor or door/window open/closed state sensor and stored in the information storage unit 61.

Note that the prediction of a survivor left in the house can be made based on the result of detection supplied from the sensor unit 10 in which the sensor 20 is the image sensor and sent from CP 14 in the client 2 to the server 3 via the transmitter 13. The image sensor is to detect the movement of an object with the use of infrared rays as having previously been described. So, it will possibly detect a creature other than a human being, for example, a dog or cat. On the account, a power consumption sensor, for example, a voltmeter, may be used as the sensor 20 in conjunction with the image sensor or in place of the image sensor to predict a survivor left in a collapsed house. At occurrence of a disaster, the survivor prediction may be done based on a detection signal when the power consumption sensor has detected a value larger than predetermined or when the variation of the power consumption exceeds a predetermine value. Namely, since the dog and cat cannot consume the electric power, it is possible to prevent mistaking of a dog or cat for a human being.

Now, there will be explained a procedure for generating disaster information at occurrence of a disaster (earthquake).

In case an earthquake is detected by the sensor unit 10 (in which the sensor 20 is an acceleration sensor) included in the client 2 in each house, earthquake information (a seismic intensity) is informed to the server 3. Also, at this time, each client 2 informs the server 3 of distortion information, fire information, collapse information, etc. on the housing, detected by another sensor unit 10.

Next, the server 3 arranges and sorts, by the disaster information providing unit 63, the disaster information supplied from the client 2 according to each district or/and disaster state to generate a disaster site map for each district or/and disaster state as district-based disaster information. More specifically, the server 3 superposes the disaster information sent from each client 2 on a map data on each district to generate a disaster site map indicative of the disaster state of each district. The user can use the terminal 4 to view the disaster site map. The disaster site map includes, for example, information on a place where a fire has broken out, place where buildings have been destroyed, survivor having failed to escape and remaining in a building, evacuation route, etc. and is edited to be understandable easily at a glance. Therefore, the user can easily know the damage to the building and safety of his family from the disaster site map. The disaster site map will help the people to start recovery of each predetermined district and rescue operation for each house correctly and rapidly.

Also, the disaster information providing unit 63 generates, based on the disaster information, a damage check map showing areas where the power transmission has been stopped, areas where the city water supply has been stopped, areas where the gas supply has been stopped, etc. With reference to this damage check map, the electric power, gas and water providing industries can know the disaster or damage state and take appropriate measures to recover the electric power supply, gas supply and water supply, respectively.

Also, the disaster information providing unit 63 may be configured similarly to the wide-area information system 5.

The information managing/providing system 1 as the embodiment of the present invention includes the plurality of clients 2, server 3 and plurality of terminals 4, connected to each other via the network to provide environmental information on a residential house having a client 2 installed therein to each of the terminals 4 normally and at occurrence of a disaster. So, various kinds of environmental information on a user's or arbitrary house can be provided from a remote site to the users of the terminals 4 (users having completed the predetermined registration). Also, at occurrence of a disaster, disaster information on a house having the client installed therein is provided to each terminal 4. Thus, disaster information concerning a disaster district can be provided to the users of the terminals 4.

Also, since the clients 2 included in the information managing/providing system 1 as the embodiment of the present invention sends and receives signals in compliance with a predetermined radio communication standard (for example, ZigBee (registered trademark)), it needs no wiring work and complicated setting work, which will contribute to reduced costs of system introduction.

In the foregoing, the present invention has been described in detail concerning certain preferred embodiments thereof as examples with reference to the accompanying drawings. However, it should be understood by those ordinarily skilled in the art that the present invention is not limited to the embodiments but can be modified in various manners, constructed alternatively or embodied in various other forms without departing from the scope and spirit thereof as set forth and defined in the appended claims.

1. An information managing/providing system in which a plurality of clients is connected to an external server that manages and provides information sent from each client-side device, wherein
each of the clients comprising:
a plurality of sensor units to detect housing-environmental information and send the detected housing-environmental information according to a predetermined radio communication standard;
a housing-environmental information storage unit to receive the housing-environmental information sent from one or more of the sensor units installed in an arbitrary place in a residential house according to the predetermined radio communication standard and store the received housing-environmental information; and
a transmitter to send the housing-environmental information stored in the housing-environmental information storage unit to a server via a network;
one of the sensor units including at least an acceleration sensor that detects a vibration in a place where it is provided, as one of the housing-environmental information, and
the server comprising:
an information storage unit to receive housing-environmental information supplied from the transmitter included in each of client-side devices and store the received housing-environmental information;
a housing-environmental information providing unit to extract arbitrary information on the basis of the housing-environmental information stored in the information storage unit and provide the extracted information to a pre-registered user via a network; and
a disaster information providing unit, put into operation at occurrence of a disaster, to generate information on a disaster to a residential house having a client installed therein on the basis of the housing-environmental information stored in the information storage.

2. The system according to claim 1, wherein
one of the sensor units includes an image sensor that detects a movement of an object in the proximity of the place where it is provided, as one of the housing-environmental information, and
the disaster information providing unit provides, based on the result of detection from the image sensor, information on the existence of a person remaining in each residential house having the client installed therein, as one of the disaster information via the network.

3. The system according to claim 1, wherein
one of the sensor units is a power consumption sensor to detect a power consumption in each residential housing as one of the housing-environmental information, and
the disaster information providing unit provides, based on the result of detection from the power consumption sensor, information on the existence of a person remaining in each residential house having the client installed therein, as one of the disaster information via the network.

4. The system according to claim 1, wherein the disaster information providing unit generates, at occurrence of a disaster, to generate information on a disaster to a residential house having a client installed therein on the basis of the housing-environmental information stored in the information storage unit and a map of a district where the residential house is.

5. The system according to claim 1, wherein at occurrence of a disaster, the housing-environmental information is provided from the client to the server at predetermined intervals.

6. An information managing/providing method in which information sent from each of a plurality of clients connected to an external server via a network is managed and provided by the server, wherein
each of the clients includes one sensor unit or more installed in an arbitrary place in a residential house to detect environmental information on the residential house and send the detected housing-environmental information according to a predetermined radio communication standard, at least one of the sensor units being an acceleration sensor to detect a vibration in a place where it is, as one of the housing-environmental information,
the housing-environmental information sent from one or more of the sensor units is received according to the predetermined radio communication standard and stored in a housing-environmental information storage unit,
the housing-environmental information stored in the housing-environmental information storage unit is sent to the server via the network,
the housing-environmental information received by the server from the client is stored in an information storage unit,
arbitrary information is extracted based on the housing-environmental information stored in the information storage unit and the extracted information is provided from a housing-environmental information providing unit to a pre-registered user via the network, and
at occurrence of a disaster, information on a disaster to a residential house having the client installed therein is generated based on the housing-environmental information stored in the information storage and the generated disaster information is provided from a disaster information providing unit via the network.

7. The method according to claim 6, wherein
one of the sensor units is an image sensor that detects a movement of an object in the proximity of the place where it is provided, as one of the housing-environmental information, and
the disaster information providing unit provides, based on the result of detection from the image sensor, information on the existence of a person remaining in each residential house having the client installed therein, as one of the disaster information via the network.

8. The method according to claim 6, wherein
one of the sensor units is a power consumption sensor to detect a power consumption in each residential housing as one of the housing-environmental information, and
the disaster information providing unit provides, based on the result of detection from the power consumption sensor, information on the existence of a person remaining in each residential house having the client installed therein, as one of the disaster information via the network.

9. The method according to claim 6, wherein the disaster information providing unit generates, at occurrence of a disaster, to generate information on a disaster to a residential house having a client installed therein on the basis of the housing-environmental information stored in the information storage unit and a map of a district where the residential house is.

10. The method according to claim 6, wherein at occurrence of a disaster, the housing-environmental information is provided from the client to the server at predetermined intervals.
